(19) United States
(12) Patent Application Publication
(10) Pub. No.: US 2014/0258067 A1
(43) Pub. Date: Sep. 11, 2014

(54) SYSTEM AND METHOD FOR FINANCIAL DATA GAP DETECTION

(71) Applicant: CHARTIQ, LLC, Crozet, VA (US)

(72) Inventor: Terrence Thorsen, Crozet, VA (US)

(73) Assignee: CHARTIQ, LLC, Crozet, VA (US)

(21) Appl. No.: 13/792,890

(22) Filed: Mar. 11, 2013

(51) Int. Cl. G06Q 40/04

(52) U.S. Cl. CPC G06Q 40/04
USPC 705/37

(57) ABSTRACT

A system and method provides for the detection of at least one gap in a value distribution for a security across a time period. The system and method receives value data for the security indicating high and low value data points. For each time interval, the system and method compares the value data for a first interval with the value data for a second interval to detect potential gap data. The method and system compares the potential gap data against future time intervals to detect value data within the potential gap data to determine actual gap data when value data for future time intervals is outside the potential gap data. The method and system computationally assembles and displays the value data actual gap data over the time period.

### RELATED APPLICATIONS

The present application relates to and incorporates herein: copending U.S. patent application Ser. No. ______ entitled “SYSTEM AND METHOD FOR DETECTION AND DISPLAY OF DIVERGENCE WITHIN A FINANCIAL DATA SET” filed Mar. ______, 2013; copending U.S. patent application Ser. No. ______ entitled “SYSTEM AND METHOD FOR DETECTION AND DISPLAY OF DIVERGENCE WITHIN A FINANCIAL DATA SET” filed Mar. ______ 2013; and copending U.S. patent application Ser. No. ______ entitled “SYSTEM AND METHOD FOR SEQUENTIAL COUNT VISUAL INDICATOR” filed Mar. ______, 2013.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The disclosed technology relates generally to analysis of financial data and more specifically to the detection of one or more gaps in financial data and the graphical illustration thereof.

### BACKGROUND

Individuals have long utilized varying techniques to estimate price movements on tradable instruments, e.g. securities. One such technique for a price estimation is the detection of a gap in the pricing of the security. A gap in the price of the equity occurs when the price of a security changes, up or down, in between market trading intervals (i.e. after trading hours on a given exchange) and no trades have been executed in that price range.

An early gap detection technique is the manual detection of the gap based on a graphical representation of the security over a time period. One such typical graphical representation is the values plotted on the y-axis and the values on the x-axis. A sample graphical representation is a candlestick graph that illustrates a box indicating opening and closing values and a line indicating a high value and a low value during the defined trading period.

In another variation, the candlestick color or display attribute (e.g. solid or in outline format) may be used to indicate if the value of the security increased or decreased during the time interval. Thus, if the price decreases, the top margin of the box represents the opening value or price of the security and the bottom margin of the box represents the closing value or price of the security. The top of the line indicates high value during the time period and the bottom of the line indicates the low value during the time period.

A gap in the price occurs when there are no intervening value points for the security in between two timeintervals. Therefore, in the above example, the detection of a gap occurs by manually tracing forward in time the security value data until there is an overlap with a future pricing. Stated in other terms, there is no gap if the security is exchanged again, later in time, at the same value as an earlier gap.

The only current technique available for gap detection with financial data is the manual inspection of the data, which is highly unreliable. The greater the volume of financial data and the length of the time period, smaller gaps can become virtually undetectable by the naked eye. Even well-trained professional analysts readily miss visual detection of gaps in the financial data.

Gaps can be interpreted to represent a market indicator for trading positions on the underlying security, such as the potential analysis of a price ceiling or a price floor. Therefore, it is extremely beneficial for analysts to readily detect gaps in the value of a security an thus there exists a need for the computerized detection of and identification of such gaps.

### BRIEF DESCRIPTION

A system and method provides for the detection of at least one gap in a value distribution for a security across a time period. The system and method includes electronically receiving value data for the security, the value data indicating, for each of a plurality of time intervals within the time period, a high value data point and a low value data point. For each time interval, the system and method compares the value data for a first interval with the value data for a second interval to detect potential gap data, wherein the second interval is a consecutive interval after the first interval. For potential gap data, the method and system compares the potential gap data against future time intervals to detect value data within the potential gap data to determine actual gap data when value data for future time intervals is outside the potential gap data. The method and system computationally assembles the value data of the security and the actual gap data and indicates on a graphical display the actual gap data concurrent with the value data of the security over the time period.

### BRIEF DESCRIPTION OF THE DRAWINGS

FIG. 1 illustrates a block diagram of one embodiment of a computing system for the graphical display of financial data and gap detection therein;

FIG. 2 illustrates a block diagram of one embodiment of another embodiment of the processing components of the gap detection system;

FIG. 3 illustrates a flowchart of the steps of one embodiment of a method for gap detection;

FIG. 4 illustrates a sample screenshot of a graphical display including gap detection illustrated therein;

FIG. 5 illustrates a flowchart of the steps of another embodiment of a method for gap detection including user interactivity; and

FIGS. 6-7 illustrate sample screenshots of graphical displays including gap detection therein.

A better understanding of the disclosed technology will be obtained from the following detailed description of the preferred embodiments taken in conjunction with the drawings and the attached claims.

### DETAILED DESCRIPTION

Embodiments of the disclosed technology comprise systems and methods for visual analysis of graphical representations of financial data, including detecting and illustration of one or more gaps in the value distribution over a defined time period.

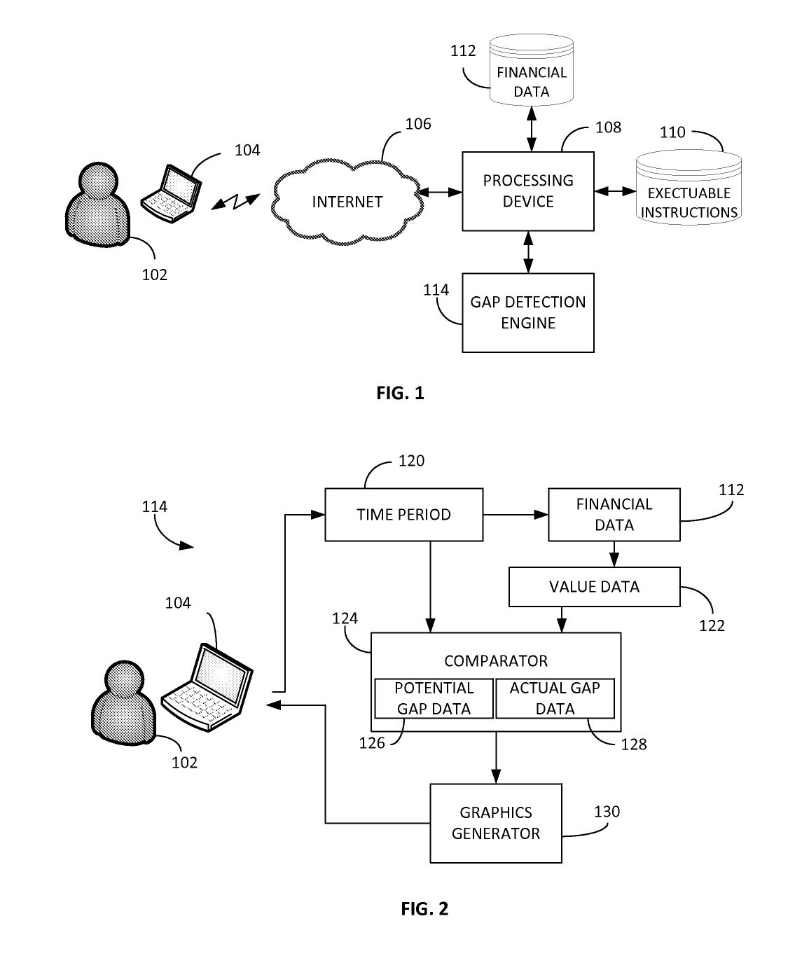

FIG. 1 illustrates one exemplary embodiment of a computing system 100 as described herein. The system 100 includes a user 102, a user computing device 104, a network 106, a processing device 108, executable instructions 110 stored in a memory device, a financial data database 112, and a gap detection engine 114. It is further recognized by one skilled in the art that additional aspects of the system 100 have been omitted for brevity purposes only.

In the system 100, the user 102 may be any user or group of users. For example, the user may be a financial analyst performing computation analysis on a company's stock. In another example, the user may be a trader or broker buying and selling stocks or other equities for clients or for managing one or funds. In yet another example, the user may be an individual performing analysis prior to considering or executing trades themselves. The user may be an expert or professional, as well as be a novice to the management and trading systems.

The user device 104 may be any suitable computing device working in either a stand alone or networked environment. For example, the user device 104 may be a laptop or desktop computer running a browser or other type of application for communicating across the network. In another example, the device 104 may be a smart phone, tablet or other mobile computing device running a browser or application for communication and user input/output. In yet another example, the device 104 can be a dedicated terminal for stock and equity management activities. In one embodiment, the device 104 interfaces across the network 106, whereby processing operations are performed on the network side, in a software-as-a-service manner. In another embodiment, processing operations described below on the network side may also be disposed within the user device 104 or distributed between the network and the device 104.

The network 106 is most generally referred to as the Internet. This network 106 may be any suitable type of network, including but not limited to a local area network, wide area network, virtual private network, among others. In general terms, the network 106 provides for data communication thereacross, including any suitable protocol transmissions and security measures as recognized by one skilled in the art. The network 106 provides the medium for data communication between the device 104 and the processing device 108.

The processing device 108 may be one or more processing devices operative to perform processing operations in response to executable instructions 110. The processing device 108 may be disposed in one or more servers or other network locations, not expressly designated in FIG. 1. The processing operations may be performed in a unitary processing system or in another embodiment may be distributed across one or more processing systems. Whereby, the processing device is operative to perform processing operations described herein such that the user 102 receives a graphical display of the visual analysis of financial data including analysis of estimated future data.

The executable instructions 110 may be software code or other types of instructions readable by the processing device 108, stored in one or more computer readable medium, such as non-transitory medium, including for example one or more data storage devices. The data storage devices may be centrally located or can be accessible in a distributed environment, as recognized by one skilled in the art.

The financial data 112 includes historical data relating to a security. As used herein, a security can be any type of stock, equity, fund, fund of funds, or other tradable or exchangeable element having a value affixed thereto. The financial data 112 may be assembled within the system 100 or in another embodiment the data 112 is provided via one or more source providers. For example, the system 100 may include financial data information feeds from market sources providing timely financial data. Thus, the database 112 of FIG. 1 can be illustrative of the data, but it is recognized that in one embodiment, the financial data is provided via one or more data feeds. Moreover, the user 102 may select the security for which the financial data is retrieved, as well as in various embodiments the time period for the underlying data.

The gap detection engine 114 may be one or more processing devices performing comparison operations of value data for the security, as described in further detail below. In one embodiment, the engine 114 may be embedded within the processing device 108, but is illustrated separate therefrom in the system 100 for illustration purposes.

Moreover, the engine 114 may be disposed in a processing system separate from the processing device 108, such as via a networked connection. For example, a third party provider may provide a technical indicator operation, such that the processing device 108 networks out to the engine 114 for the performance of gap detection operations.

In one embodiment, the processing device 108 may include the performance of additional technical indicator routines on the financial data, including providing such indicator data concurrent with the graphical display of the financial data. Various technical indicators may be utilized, as recognized by one skilled in the art, including but not limited to: Moving Average; 9/13 Count; Welles Wilder Smoothing; Williams % R; Williams Accumulation Distribution; Volume Oscillator; Vertical Horizontal Filter; Ultimate Oscillator; and others.

FIG. 2 illustrates an expanded display of one embodiment of the gap detection engine 114. In the illustrated embodiment, the engine 114 includes a time period selection device 120, financial data 112, value data 122, a comparator 124, including a potential gap data storage device 126 and an actual gap data storage device 128, and a graphics generator 130. These components interact with the user 102 and the user computing device 104 via a networked or direct connection (not expressly illustrated). It is recognized by one skilled in the art that additional embodiments include other processing engines or component not expressly illustrated such that the elements of FIG. 2 are representative, and not limiting, in nature.

In the system of FIG. 2, the user 102 may select a time period via the selector 120. The time period represents one or both of the time period from the display of financial data and the intervals to be displayed. For example, the user may select a time period of the previous 6 months with a time interval of one day.

The financial data 112 is received from any number of available data sources, including one or more financial data feeds or financial data services. In one embodiment, (not expressly illustrated in FIG. 2), the user 102 selects the security via a graphical user interface such that the financial data 112 includes the value data 122 for the indicated security.

As used herein, value data is the data included within the financial data that indicates the value, such as the price, of the security. By way of example, if the security is a publicly traded stock, the value data represents the sale price for the public sale and trading of the stock. In the event the time interval is a single trading day, the value data would include the range of trading values for the stock during the day, including an open price, a closing price, a high trade mark, a low trade mark and the values therebetween. Thus, with the time period 120 and the financial data 112, the value data 122 is the extracted subset of the full financial data 112.

In the engine 114 of FIG. 2, the comparator 124 therein performs numerous comparison operations to detect one or more gaps. The comparator 124 performs comparison operations of the value data on an interval by interval basis. In the example of an interval being a single day, the comparator begins at the first time interval in the time period, comparing the value data for the security on the time interval against future or later-in-time time periods.

As noted above, a gap occurs when there is a gap in the price or value of a security such that the value is not repeated in future time intervals. Therefore, the comparator 124 takes value data at a base time interval and compares that base data against future intervals to determine if the value data is repeated at any of the time intervals.

As described in further detail below, the comparator performs a first level of comparison to determine potential gap data. The potential gap data occurs when there is a gap between the price of value data of the security from a first time interval to a second time interval. The potential gap occurs when either a high value of interval one is less than a low value at interval two or the low value of interval one is greater than a high value of interval two.

The presence of a potential gap data does not provide for a real gap in the financial data because the an actual gap does not exist if future time interval values intersect the potential gap range. Thus, the comparator 124 performs further comparison operations, comparing the potential gap data with the financial data for future intervals to detect if there is an overlap.

If there is an intersection of the value data, the comparator also detects the scope of the intersection. If a future interval value data fully encapsulates the potential gap data, the comparison process terminates and no actual gap is detected. If the future interval value data partially encapsulates the potential gap data, the potential gap data is then modified to adjusts the gap range to exclude the intersected value data. If the future interval value data never crosses the potential gap data, e.g. the value data is never repeated, the potential gap data is maintained. After the full comparison for the future intervals in the time period, any remaining potential gap data is then defined as actual gap data.

The comparator provides the financial data 112 and the actual gap data 128 to the graphics generator 130, which may be a graphics engine plotting the financial data versus the time interval. The generator 130 therein includes the graphical display of the gap data 128 for presentation to the user 102 via the user device 104.

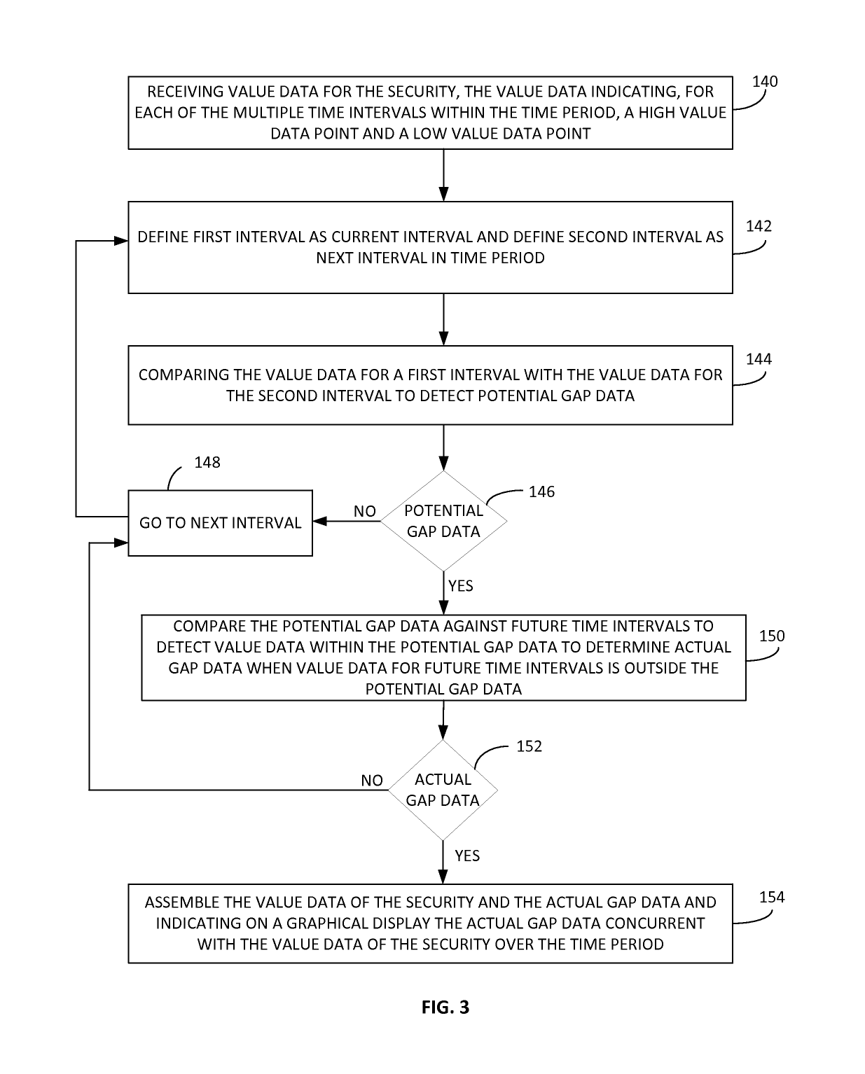

FIG. 3 illustrates a flowchart of the steps of one embodiment of a method for the detection of at least one gap in a value distribution for a security across a time period. The value distribution represents the values for the security across the designated time period.

In one embodiment, step 140 is receiving value data for the security, the value data indicating a high value data point and a low value data point for each of the multiple time intervals. The value data may also include inter-period values, such as by way of example an interval opening price, an interval closing price and the range of values therebetween.

As described above, the value data may be received one or more value data sources, such as financial data source provider including up to date, real time or time-delayed financial data. In another embodiment, the financial data may be historical data from one or more historical data sources.

In the embodiment of FIG. 3, step 142 is to define a first interval as the current time interval and the second interval as the next time interval. In the example described herein, a sample interval may be a single day, but it is recognized that the interval may be any suitable interval as recognized by one skilled in the art.

Thus, in this example, the first interval may be the first day in the time period and the second interval is the second day in the time period. As the potential gap data is determined based on a gap from one interval to the next, the present embodiment performs an interval to interval comparison.

Step 144 is comparing the value data for a first interval with the value data for the second interval to detect potential gap data. In one embodiment, the comparison steps operates to detect when there is a gap in the value data from the first to second interval, or stated another way, where the value data of the second interval does not overlap the value data of the first interval. Therefore, one comparison operation to determine if the high value data for the first interval is less than the low value data for the second interval or if the low value data for the first interval is greater than the high value data for the second interval. If either occurs, this indicates that there is a gap in the value data and hence is potential gap data.

Step 146 is the decision step if there is potential gap data. The potential gap data indicates the gap from first to second interval and thus further comparison is required to detect if this is actual gap data. As used herein, the potential gap data may include range values indicating a high end of the value range and a low end of the value range, being based on the corresponding values in the first and second interval value data.

If, in step 146, there is no potential gap data, this indicates that the second interval value data intercepts the first interval value data. The method then proceeds to step 148 to go the next interval. In this case, the second interval, using the daily interval example of the second interval being the second day, would become the first interval and the third day would become the second interval. The method therein reverts to step 142 to seek detection of potential gap data in steps 142, 144 and 146.

If the inquiry of step 146 is the detection of potential gap data, the method therein proceeds to step 150 for the determination if the potential gap data can be defined as actual gap data. Step 150 compares the potential gap data against future time intervals to detect value data within the potential gap data to determine actual gap data when value data for future time intervals is outside the potential gap data.

Step 150 provides for the comparison of the gap range against future interval data until there is an overlap of the value data or all intervals have been compared. As described in further detail below, step 148 may provide for modification of the potential gap data to define the actual gap data as a portion of the potential gap data.

Step 152 is another decision step to determine if there is actual gap data. If the analysis of the potential gap data fails to yield any actual gap data, the method reverts the step 148 to increment the intervals. If the inquiry of step 152 is in the affirmative, step 154 provides for the assembling the value data of the security and the actual gap data and indicating on a graphical display the actual gap data concurrent with the value data of the security over the time period.

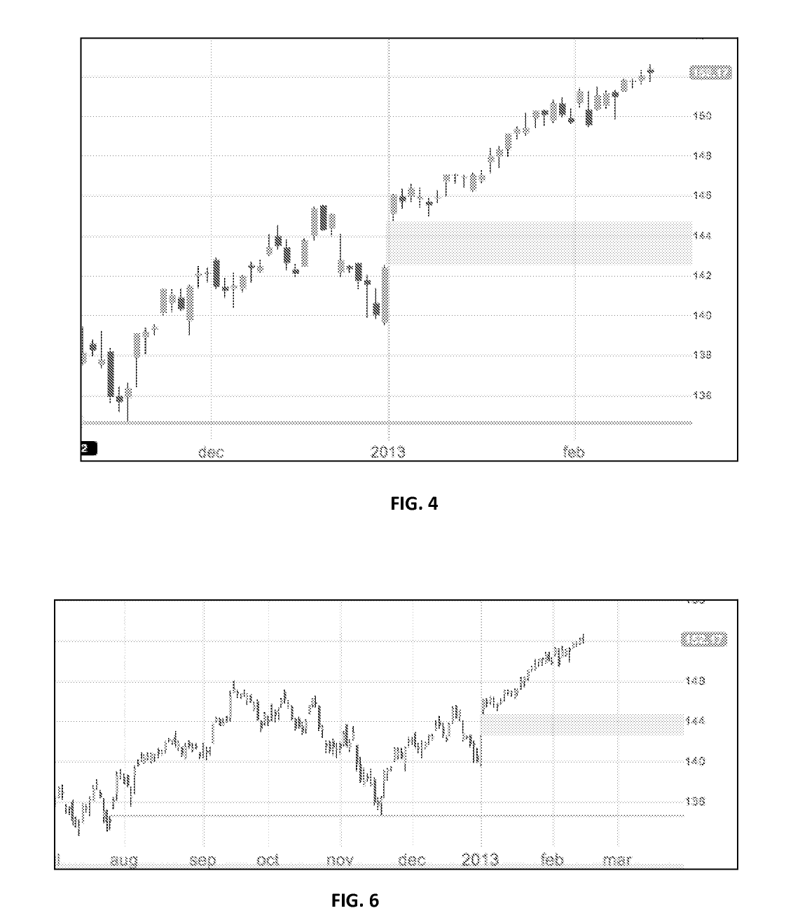

Therein, step 152 provides for the graphical plotting of the security financial data over the time period and the overlay or inclusion of the gap data thereon. FIG. 4 illustrates a sample screenshot of a graphical display including financial data over the time period with the illustration of the actual gap data. In this embodiment, the actual gap data is illustrated using a blocked display extending from the origination of the gap to the end of the display time period.

Moreover, the methodology of FIG. 3, including additional embodiments and variations thereof, may be performed by the processing devices of FIG. 1 and FIG. 2, including in response to executable instructions. Additional embodiments, as described herein, further include user interaction from input from the user 102 via the computing device 104. Moreover, the screenshot illustrates the embodiment of the intervals in days and the value data displayed in a candle graph.

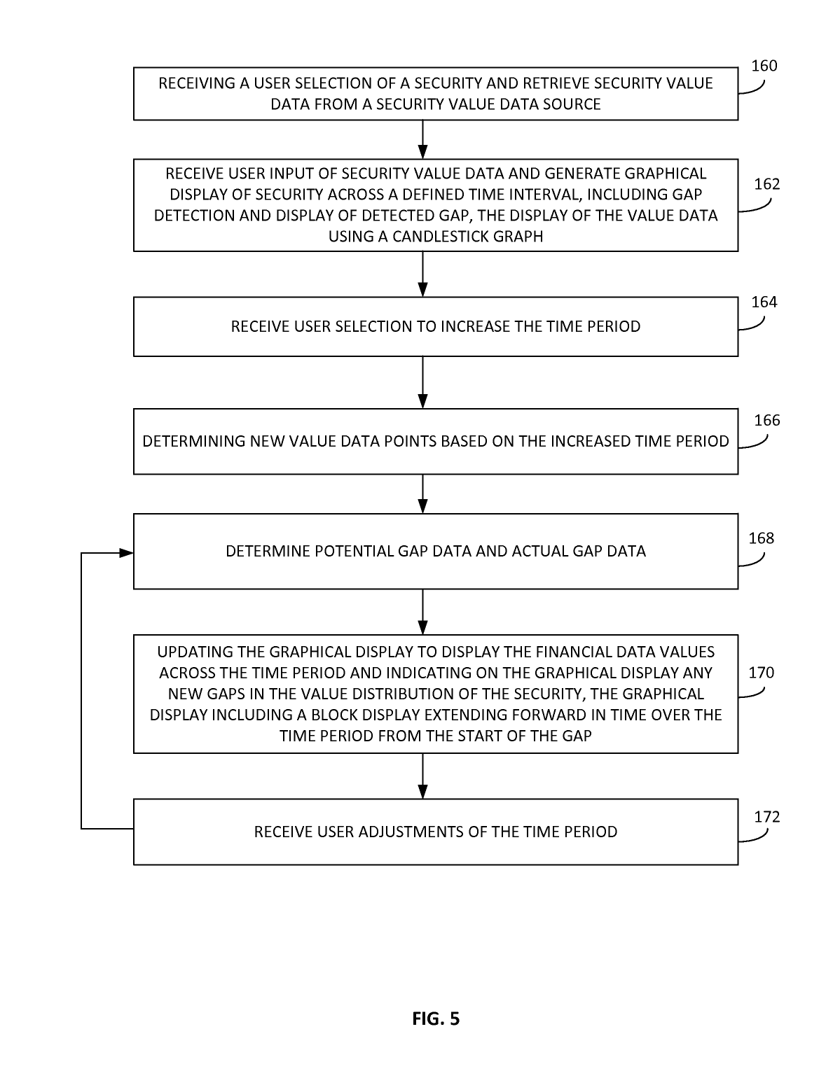

FIG. 5 illustrates a flowchart of the steps of further embodiments of the method for detection of one or more gaps in the value distribution of a security. These operations may be performed by the processing systems of FIGS. 1 and 2, or other processing environments recognized by one skilled in the art.

In the embodiment of FIG. 5, a first step, step 160, is receiving a user selection of a security and retrieving the security value data from a security value data source. In this embodiment, the user may utilize a graphical user interface to select one or more securities having value data available from at least one source. For example, one technique may be a search bar where a user can type in a name or other indicator for the security. In one example, the user interface may include user preferences having a list of the user's favorite or preferred securities. In another example, the input may be from meta data or other relational data from secondary sources, such as an application recognizing security information from articles or other data sources, extracting the security identifier as an input source and then using that as an input for a user selection.

Using techniques described above, the methodology therein receives the financial data for processing and utilization for any number of analytical operations. Step 162 provides receiving user input of security data and generating a graphical display of the security across a defined time interval, including gap detection and display of detected gap, the display of the value data using a candlestick graph. This step 162 may include encompassing numerous steps of the methodology of FIG. 3, omitted for brevity purposes only.

Step 164 is to receive user selection to increase the time period. This user selection may be via a graphical user interface, including in one embodiment a pull down menu of available intervals. In this example, the user may select to go further back in time by extending the time interval from an earlier start date.

When increasing the time interval, this therein increases the comparison operations for determining potential gap data and thus actual gap data. Since gap data is based upon an initial gap between intervals and no future value data overlapping the gap, the comparison operations are performed again. Step 166 provides determining new value data points based on the increased time period. This step may include accessing additional financial data as necessary for the new time period, where such data may be received from one or more financial data sources or may already be within the previously received financial data and previously filtered out.

Step 168, for each of the new value data points, includes determining potential gap data and therein determining actual gap data from the potential gap data. Step 168 may include the re-operation of various steps of FIG. 3 described above.

In response to the determination of the actual gap data, the method provides in step 170 for the generation of the graphical display adjusted for the changes to the time period and the inclusion of additional gap data.

By way of example and comparison, FIG. 6 includes a sample screenshot of the same security illustrated in screenshot of FIG. 4, but wherein the time period is extended back in time. Based on the extension of the time interval, a second gap is detected and thus visibly displayed.

With reference back to FIG. 5, step 172 includes receiving user adjustment of the time period. As noted above, the intervals may be any suitable time period, such as but not limited to months, weeks, days, hours, minutes, seconds, etc. Thus, in this example, the user may select a pull down menu and adjust an interval from an original selection of weeks to days. As the user adjusts the time period, methodology reverts to step 168 for further processing of the gap data.

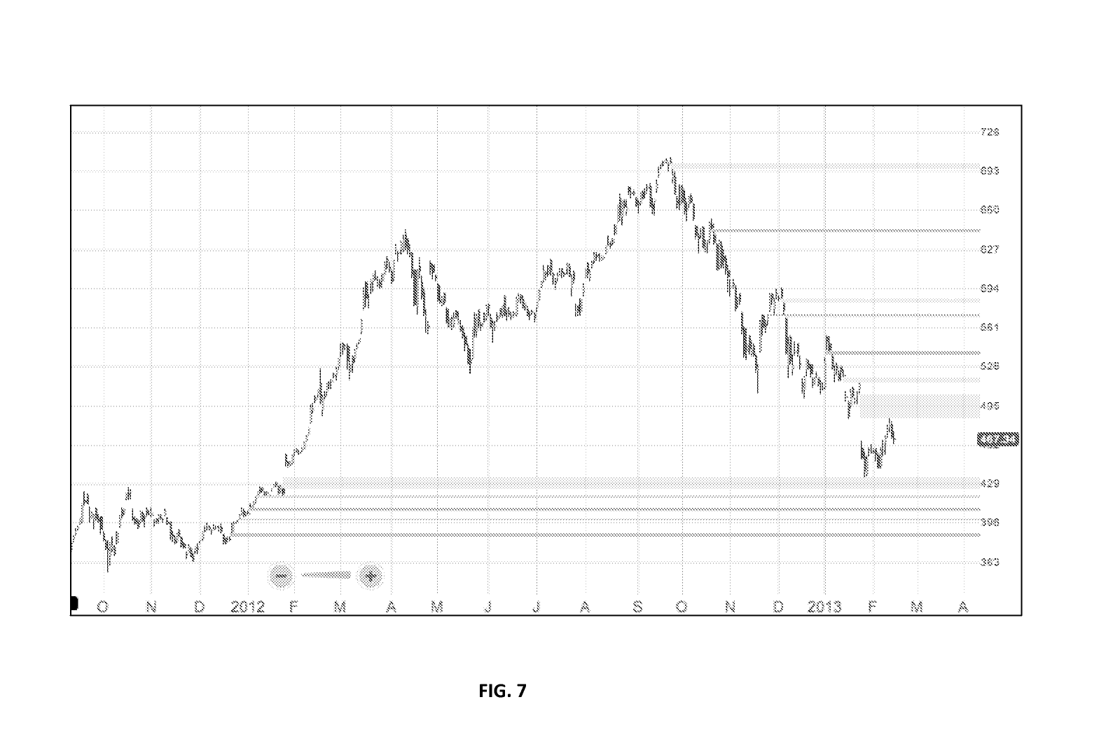

FIG. 7 illustrates a screenshot of another security having an expanded view of the financial data and the inclusion of the detected gaps. FIG. 7 illustrates the inclusion of gaps occurring when the security value is increasing and when the security value is decreasing.

Therefore, the method and system described herein provides for the detection and display of gap data with financial data. Whereas prior techniques required the user to visually detect the gap, this technique was extremely unreliable and error prone. Moreover the prior techniques were extremely labor intensive, failing to take advantage of processing operations described herein. The detection of gaps in the data provide increased analytic opportunities for individuals studying and/or analyzing financial information. The present method and system further includes user interface operations for selecting various securities and adjusting or modifying the time period and/or intervals, updating such changes on the graphical display with the inclusion of corresponding detected gap data.

FIGS. 1 through 7 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A method for the detection of at least one gap in a value distribution for a security across a time period, the method comprising:
electronically receiving value data for the security, the value data indicating, for each of a plurality of time intervals within the time period, a high value data point and a low value data point;
for each time interval, electronically comparing the value data for a first interval with the value data for a second interval to detect potential gap data, wherein the second interval is a consecutive interval after the first interval;
for potential gap data, comparing the potential gap data against future time intervals to detect value data within the potential gap data to determine actual gap data when value data for future time intervals is outside the potential gap data;
computationally assembling the value data of the security and the actual gap data; and
indicating on a graphical display the actual gap data concurrent with the value data of the security over the time period.

2. The method of claim 1 further comprising:
defining a gap range in the potential gap data as a difference between at least one of: the high value data point of the first interval and a low value data point of the second interval if the high value data point of the first interval is less than the low value data point of the second interval; and the low value data point of the first interval and a high value data point of the second interval if the low value data point of the first interval is greater than the high value data point of the second interval;
comparing the gap range against value data for future time intervals to detect any future value data within gap range; and
defining the actual gap where there is no value data for future time intervals within the gap range.

3. The method of claim 2 further comprising:
when any of the value data in the future intervals repeats a portion of potential gap data, modifying the potential gap data to exclude the repeated value data.

4. The method of claim 1, further comprising:
receiving a user selection of an updated time period;
for new value data included based on the updated time period, detecting potential gap data and for potential gap data detecting actual gap data;
updating the graphical display to include the new value data and actual gap data.

5. The method of claim 1 further comprising:
receiving a user selection of the security; and
electronically receiving the value data from security value data source.

6. The method of claim 1, wherein the step of computationally assembling includes plotting the value data against the plurality of time points.

7. The method of claim 1, wherein the indication of the gap data is illustrated via a graphical representation extending across future time intervals with a bottom margin of the graphical representation at a low value in the gap and a top margin of the graphical representation at a top value in the gap.

8. The method of claim 1, wherein the value data is represented using a candlestick representation for the value data at corresponding time intervals.

9. A system for the detection of at least one gap in a value distribution for a security across a time period, the system comprising:
a computer readable medium having executable instructions stored thereon; and
a processing device, in response to the executable instructions, operative to:
electronically receive value data for the security, the value data indicating, for each of a plurality of time intervals within the time period, a high value data point and a low value data point;
for each time interval, electronically compare the value data for a first interval with the value data for a second interval to detect potential gap data, wherein the second interval is a consecutive interval after the first interval;
for potential gap data, compare the potential gap data against future time intervals to detect value data within the potential gap data to determine actual gap data when value data for future time intervals is outside the potential gap data;
computationally assemble the value data of the security and the actual gap data; and
indicate on a graphical display the actual gap data concurrent with the value data of the security over the time period.

10. The system of claim 9, the processing device, in response to further operating instructions, further operative to:
define a gap range in the potential gap data as a difference between at least one of: the high value data point of the first interval and a low value data point of the second interval if the high value data point of the first interval is less than the low value data point of the second interval; and the low value data point of the first interval and a high value data point of the second interval if the low value data point of the first interval is greater than the high value data point of the second interval;
compare the gap range against value data for future time intervals to detect any future value data within gap range; and
define the actual gap where there is no value data for future time intervals within the gap range.

11. The system of claim 10, the processing device, in response to further operating instructions, further operative to:
when any of the value data in the future intervals repeats a portion of potential gap data, modify the potential gap data to exclude the repeated value data.

12. The system of claim 9, the processing device, in response to further operating instructions, further operative to:
receive a user selection of an updated time period;
for new value data included based on the updated time period, detect potential gap data and for potential gap data detecting actual gap data;
update the graphical display to include the new value data and actual gap data.

13. The system of claim 9, the processing device, in response to further operating instructions, further operative to:
receive a user selection of the security; and
electronically receive the value data from security value data source.

14. The system of claim 9, wherein the step of computationally assembling includes plotting the value data against the plurality of time points.

15. The system of claim 9, wherein the indication of the gap data is illustrated via a graphical representation extending across future time intervals with a bottom margin of the graphical representation at a low value in the gap and a top margin of the graphical representation at a top value in the gap.

16. The system of claim 9, wherein the value data is represented using a candlestick representation for the value data at corresponding time intervals.

17. Computer readable medium having executable code stored thereon that when executed by a processing device provides for a method for the detection of at least one gap in a value distribution for a security across a time period, comprising:
executable code electronically receiving value data for the security, the value data indicating, for each of a plurality of time intervals within the time period, a high value data point and a low value data point;
executable code, for each time interval, electronically comparing the value data for a first interval with the value data for a second interval to detect potential gap data, wherein the second interval is a consecutive interval after the first interval;
executable code, for potential gap data, comparing the potential gap data against future time intervals to detect value data within the potential gap data to determine actual gap data when value data for future time intervals is outside the potential gap data;
executable code computationally assembling the value data of the security and the actual gap data; and
executable code indicating on a graphical display the actual gap data concurrent with the value data of the security over the time period.

18. The computer readable medium of claim 17 further comprising:
executable code defining a gap range in the potential gap data as a difference between at least one of: the high value data point of the first interval and a low value data point of the second interval if the high value data point of the first interval is less than the low value data point of the second interval; and the low value data point of the first interval and a high value data point of the second interval if the low value data point of the first interval is greater than the high value data point of the second interval;
executable code comparing the gap range against value data for future time intervals to detect any future value data within gap range; and
executable code defining the actual gap where there is no value data for future time intervals within the gap range.

19. The computer readable medium of claim 18 further comprising:
when any of the value data in the future intervals repeats a portion of potential gap data, executable code modifying the potential gap data to exclude the repeated value data.
